(19) United States
(12) Patent Application Publication
(10) Pub. No.: US 2009/0253364 A1
(43) Pub. Date: Oct. 8, 2009

(54) Rechargeable fire containment and smoke extraction system

(76) Inventor: Mark Henry, Broken Arrow, OK (US)

Correspondence Address: Mark Henry, 1907 West Houston #7, Broken Arrow, OK, 74012, US

(21) Appl. No.: 12/080,834

(22) Filed: Apr. 7, 2008

(51) Int. Cl. G08B 17/10; F24F 7/06

(52) U.S. Cl. 454/229; 340/577

(57) ABSTRACT

A battery operated smoke detection and smoke extraction system for use within a building with walls and ceilings. The system detects the presence of smoke, and provides means to contain fires within the area of origination. The system feeds positive airflow to a fire by extracting smoke into a dedicated ductwork system, whereby it is exhausted outside through the building envelope in a confined manner. The system decreases the possibility of fire back draft occurring. The system is comprised of a modified smoke detector, which activates a fan installed in a multi port manifold. Individual dedicated ducts, each serving individual rooms, are connected to the manifold. Each duct has a ceiling mounted back draft damper, for energy efficiency. The manifold is provided with a chimney and a decorative spark arrestor chimney termination. The system is powered by means of rechargeable batteries within a fireproofed recharging receptacle.

### FIELD OF THE INVENTION

The present invention relates to smoke detection and ventilation systems and more particularly to a system for containing fires and ventilating smoke so as to prevent smoke inhalation and property damage due to smoke, provide additional evacuation time, decrease the possibility of fire back draft occurring, and alert occupants of a building to the presence of smoke. The present invention further provides for a dedicated smoke extraction system designed to be adapted to existing residential or commercial buildings or installed during new construction. The extraction system will detect smoke, remove it, and further provides for sequential and separate room activation. The system also contains the fire to the area that it started in by feeding positive air flow to the fire by means of drawing the smoke and heated air into the extraction system.

### BACKGROUND ART

Various attempts have been made at providing safety mechanisms in buildings which alert the occupants thereof to fire through the detection of smoke. However, the fact that people have become alerted to the presence of smoke does not necessarily enable their evacuation or prevent property damage due to smoke. The majority of fire related deaths, approximately eighty (80%) percent are due to smoke inhalation and not the fire directly. The mere presence of smoke, regardless of the inhabitant's awareness of it, is dangerous. Smoke causes property damage, it is difficult to see through and breathing problems making evacuation from a smoke filled environment difficult, in some cases impossible. In the event that additional time is needed to evacuate small children, handicapped persons, or elderly persons from a burning building, the occupants of the building and/or rescuers are placed in jeopardy of smoke inhalation. Thus, simply alerting occupants to the existence of smoke is not enough to eradicate all of the problems caused by smoke in a building. Fire related back draft is a present danger for firefighting personnel upon entering a room where a fire is occurring. There are instances where the removal of smoke from a building is preferably accomplished without alarming the occupants. In the case of restaurants, bars, lounges, dance halls and such places where there is likely to be an accumulation of smoke due to cigarettes, cigars, or pipes, there is no need for an alarm, yet the removal of the smoke once it has reached a predetermined level, is desirable. Smoke detectors have become ubiquitous in businesses and residences throughout our country. In many instances they are required by law. Accordingly, smoke detectors play a significant role in preserving life and property. Prior art illustrates there are other smoke extraction devices designed for extracting smoke. Examples of these are as follows:

U.S. Pat. No. 2,586,797 to: James Dunlop et al. Issued: Feb. 26, 1952, which shows a system for protecting one portion of a building against fumes resulting from fires in another portion of the building, the system being vented to outdoors using ducts between rooms or building portions;
U.S. Pat. No. 3,741,101 to: Albert S. Sheppard Issued: Jun. 26, 1973, illustrating a gravity operated heat sensing roof ventilator;
U.S. Pat. No. 3,826,180 to: Toshikazu Hayashi Issued: Jul. 30, 1974, which provides a window ventilator with a smoke sensing unit and a 2 speed fan;
U.S. Pat. No. 3,884,133 to: Edward J. Miller Issued: May 20, 1975, teaches a siamesed air conditioning ductwork, where smoke may be drawn out of one portion of the air conditioning ductwork;
U.S. Pat. No. 3,923,096 to: Cornelis van der Lely Issued: Dec. 2, 1975, discloses prefabricated modular building sections with airspace between stacked units, the airspace is divided to provide air handling capability;
U.S. Pat. No. Des. 3,926,101 to: Cyril H. Moss Issued: Dec. 16, 1975, illustrating the smoke sensor device that engages a pressurizing fan to increase air pressure within a smoke zone;
U.S. Pat. No. 4,063,595 to: Leonard Phillips Issued: Dec. 20, 1977, an air conditioning unit with a smoke sensor enabled to engage water spray into the airstream;
U.S. Pat. No. 4,765,231 to: Michael J. Aniello Issued: Aug. 23, 1988, teaches a reversible fan within an air conditioning unit, which is responsive to a smoke detector;
U.S. Pat. No. 4,818,970 to: Anthony Natale, et al. Issued: Apr. 4, 1989, provides a radio frequency shutoff of air handling system, coupled to smoke detector;
U.S. Pat. No. 5,260,691 to: Jia-Ming Shyu Issued: Nov. 9, 1993, discloses an air conditioning unit with smoke sensing alarm function;
U.S. Pat. No. 5,300,923 to: Ralph W. Gruber Issued: Apr. 5, 1994, providing a vent hood fan which deactivates the smoke sensor;
U.S. Pat. No. 6,053,809 to: Henry M. Arceneaux Issued: Apr. 25, 2000, smoke sensor engages a ventilating ceilint tile panel within a suspended ceiling; an exhaust fan is optional;
U.S. Pat. No. 6,118,381 to: Robert Wilton James Issued: Sep. 12, 2000, illustrates the smoke sensor which shuts off the fan and pump in a heat pump unit;
U.S. Pat. No. 6,776,708 to: Daoutis et al. Issued: Aug. 17, 2004, which teaches the reversible air conditioning unit responsive to a smoke sensor.

Review of the foregoing prior art reveals that currently there is no method of detecting smoke within individual rooms of a building, and provide automatic smoke evacuation through a dedicated, centralized duct system. Further, none of the smoke or smoke and fire control methods or apparatus of the prior art appear to achieve the high degree of control of smoke reduction of back draft possibility, and containment of building fires desired by fire safety systems designers and fire safety authorities. While these prior smoke extraction systems may be suitable for the purposes for which they were designed, they further do not provide for a cordless smoke detection and ventilating system, embodied as the present invention, hereafter described.

### SUMMARY

The present invention provides a dedicated rechargeable system and device, which is used to detect the presence of smoke, alert occupants to the presence of smoke, and remove the smoke from individual rooms through an exhaust chimney. The system helps to contain the fire to the area that it started in by feeding positive airflow to the fire by means of drawing the smoke out through the extraction system. The present system allows for firefighter time savings, as it eliminates the current directive for firefighters to get on the roof of a burning building to vent the fire. The system decreases the possibility of fire back draft occurring, providing enhanced safety for firefighters. The device may be used in connection with other standard alarm or environmental control systems.

The device of the present invention comprises a multi port manifold unit, which may be installed in a ceiling of a building where the space above the ceiling is appropriately sized. When smoke is detected, an exhaust fan is engaged, allowing smoke to flow to the manifold through an intake duct placed to penetrate the ceiling. From there it will be exhausted out of the building by the exhaust chimney and the exhaust fan which is electrically connected so as to turn on when smoke is detected. Each individual room in the dwelling is served in like manner.

The present cordless invention is preferably electrically powered by means of readily available 24 volt rechargeable batteries such as found in cordless tools. The device operates independently of the household electrical source, although the rechargeable batteries are kept to optimum charge through use of a charge maintenance device connected to the home electrical supply.

It is thus a primary object of the present invention to provide an independently powered system for removing smoke from an occupied area within a building and directing it to an dedicated exhaust system, in order to prevent injury to, and save time for fire response personnel, minimize property damage, smoke inhalation, and the general irritation caused by a smoke filled environment. The system helps in containing the fire to the area that it started in by feeding positive airflow to the fire by means of drawing the smoke out through the extraction system.

It is a further object of the system of the present invention to provide a smoke extraction device that is adaptable for use with existing alarm and environmental control systems within a building, which may be installed above a ceiling, utilizing the attic space.

It is a still further object of the system of the present invention to provide an alarm less system for removing smoke from an occupied area within a building to alleviate the irritations of accumulated smoke, particularly in social environments.

It is a particular object of the present invention to provide apparatus for accomplishing the method of economically evacuating smoke and noxious fumes from an area in the building where it is being generated and accomplishing this work by utilizing a dedicated duct work combined with back draft dampers for the purpose.

It is another object of the invention to decreases the possibility of fire back draft occurring within rooms of a burning building.

Other advantages, achievements and objects of the present invention will become apparent in considering the preferred embodiment described below.

### BRIEF DESCRIPTION OF THE DRAWINGS

FIG. 1 is a side view of the preferred embodiment of the system of the invention adapted for use when the attic space above the ceiling is used, residential application.

FIG. 2 is a cutaway of the multi port manifold showing the motor and fan.

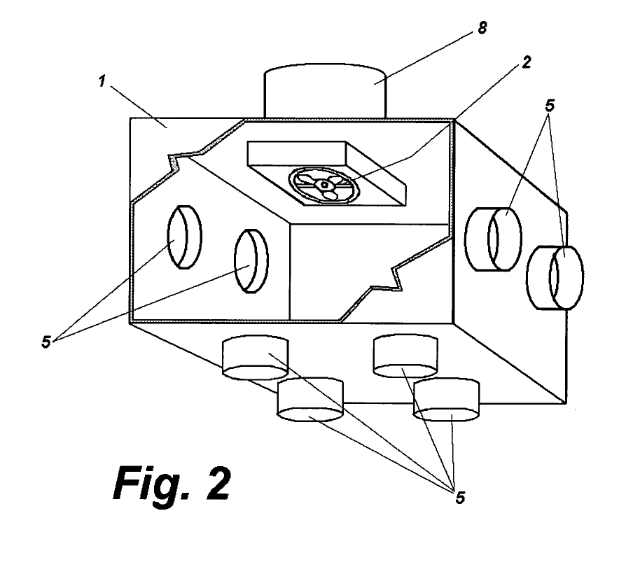

FIG. 3 is a circuit diagram illustrating the fan relay in the smoke detector connected to the fan motor, with battery shown and re-charger connected to building electric supply.

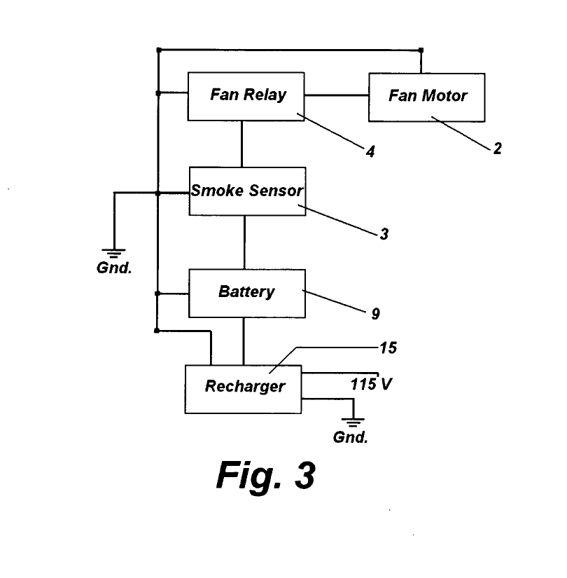

### DETAILED DRAWINGS DESCRIPTION

For a further understanding of the nature and objects of the present invention, reference the following detailed description, in conjunction with the accompanying drawings. In its present configuration, the fire containment and smoke extraction system is comprised of the following components: The smoke detector 3 and it's fan relay 4; the battery 9, with it's fireproofed recharging receptacle 15; the multi-port manifold 1 with it's multi-speed fan 2; the inlet nipples 5, the dedicated ductwork 6; the ceiling mounted back draft damper 7; the outlet chimney duct 8 and it's decorative cap 9.

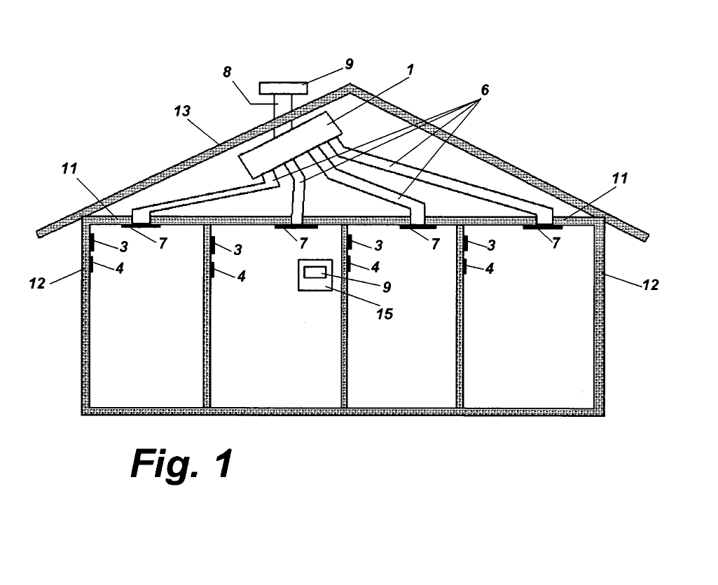

As seen in FIG. 1, dwelling comprises a floor 10, a ceiling 11, walls 12, a roof 13, and an attic 14. A multi-port smoke extraction manifold 1 embodying my invention is shown installed in the attic 14. Shown is a smoke detector 3 housing, containing a smoke detector 3, of well-known type, such as a photoelectric type smoke detector or an ionization type smoke detector. Smoke detector 3 housing contains the fan relay 4 and the smoke detector 3 device. The smoke detector 3 is fabricated with or without an audible alarm as desired, The illustrated embodiment is generally controlled only by a smoke detector 3 but may be interfaced with another or existing alarm system, in which case the smoke detector 3 would not need to be used. The device may be used in connection with other standard environmental controls such as a humidistat, thermostat or timer.

When predetermined smoke levels are detected by the smoke detector 3, the fan relay 4 within the detector 3 completes the electrical circuit to the exhaust fan 2. The fan relay 4 activates the exhaust fan 2 to begin removal of smoke from the room. Upon activation by a single detector 3, the fan 2 spins to evacuate smoke at a low speed. If additional smoke is detected by a second detector 3, within adjacent rooms, the second detector 3 energizes and the fan 2 will then spin at medium speed, evacuating smoke more efficiently from both rooms. A third or successive detector 3 will likewise sequentially energize the fan 2 to spin at high speed.

The multi port manifold 1 houses the fan 2, motor, and speed control. Preferably, the manifold 1 is of galvanized metallic construction. The manifold 1 is provided with a multiplicity of inlet nipples 5 upon the outer sides of the manifold 1. The manifold 1 embodies a box-like structure for simple installation in the attic space 14 above the ceiling 11. The manifold 1 attaches to the building framing, which may, for example, be made of wood.

A single enlarged exhaust chimney 8 projects from the uppermost face of the manifold 1. The manifold 1 may be insulated, as well as the chimney 8. Optional insulation, which may be a one (1″) inch thick ceramic refractory fiber blanket, surrounds the manifold. Thereby, the manifold 1 of the present invention has a three (3) hour Underwriters Laboratories Fire Rating Classification, which meets or exceeds almost all Ceiling Fire Ratings. This embodiment of the device is particularly suitable for commercial use. It can be installed in a drop ceiling but could also be adapted to other ceilings as would be readily obvious to one skilled in the art.

One smoke inlet duct 6 serves each nipple 5 upon the manifold 1, and each duct 6 is attached to the room ceiling 11 by counterweighted back draft dampers 7, which serve as the inlet portal for the duct 6. The back draft damper 7 also serves as ceiling 11 mounting flanges and decorative ceiling diffusers for the room. The smoke inlet duct 6 (which may be 6″ round or greater) and the back draft damper 7 are preferably constructed of metal. However, flexible metal foil tubing may be employed for the duct 6 as necessary. The back draft damper 7 remains in the closed position until smoke is detected by the smoke detector 3. The back draft damper 7 opens upon fan 2 activation, and smoke is pulled into the intake duct 6 served by the damper 7.

A rechargeable 24 volt battery 9 serves to electrically power the present smoke evacuation system. (The fan 2, the smoke detector 3, and fan relay 4) Preferably, this battery 9 is of the rechargeable type utilized by modern cordless tools. A fireproofed battery housing and receptacle 15 is conveniently and centrally located within the building for accessibility and charge monitoring. A secondary backup battery (not shown) is provided for the homeowner, and is separate from the system. A charge monitor is provided upon the receptacle 15, and operates in similar function as those found in recreational vehicles. The charging receptacle 15 provides the recharging function for the battery 9. The charging receptacle 15 is electrically powered by building current. However, in commercial applications, the power source may be an Underwriters Laboratories listed auxiliary 12/24 VDC emergency power source with an automatic cut-off charger to maintain it at full charge, without overcharging. It should preferably house a type two suspended or gelled electrolyte battery, sealed, and have a built-in relief valve. This type of battery will melt instead of possibly exploding in the event of a fire. In this manner, the present smoke evacuation system will operate independently from the buildings electrical power supply. A wall switch (not shown) may be included to turn on the fan 2 to aid in manual removal of smoke from the building.

The chimney 8 exits the upper face of the manifold 1 and penetrates the buildings roof 13, or wall 12, as applicable. The chimney 8 is sized to accommodate the total airflow (smoke-flow) allowed from the combined intake ducts 6. The chimney 8 is preferably of stainless metal construction. A suitable decorative cap 9 serves as the uppermost termination for the chimney 8, while also providing a cleanout function, and a pleasing outward appearance. Although it is anticipated that the present smoke extraction system is built and intended to allow for one time use during a building fire event, and then be retrofitted or replaced, it may be found durable enough to withstand multiple fire events with negligible damage.

A commercial embodiment of the device may be fabricated to operate the smoke detector 3 without an audio alarm, and with a wall switch override. It can be installed in a drop ceiling 11 but could also be adapted to other ceilings 11 as would be readily obvious to one skilled in the art. An embodiment of the detector 3 adds the function of a telephonic connection, to enable dial-out and provide address identification, which is relayed to local 911 or fire dept. operations. A variation provides an outdoor audio alarm, which becomes active upon smoke extraction system activation, to assist fire control personnel in locating the building during a fire event. The chimney cap 9 is provided with external identifying markings, which are recognizable from a distance, further informing fire control personnel to the presence of the system. Other variations on the system of the present invention include using a different size fan 2, multiple fans 2, or an alternative damper to the back draft damper 7, utilizing insulated ducts 6, or hardwiring the detector 3 and fan 2 to line voltage, or combining the fan relay 4 with the detector 3.

Because many varying and different embodiments may be made within the scope of the inventive concept(s) herein taught, and because many modifications may be made in the embodiments herein detailed, it is understood that the details herein are to be interpreted as illustrative and not in a limiting sense. Accordingly, although there has been disclosed and described what at present is deemed to be a preferred embodiment of the fire containment and smoke extraction system, it will be obvious to those having ordinary skill in the art that various modifications can be made to the embodiments of the invention described herein, without departure from the scope and spirit of the appended claims.

What is claimed is:

1. A battery operated fire containment and smoke extraction system, and method for use in a building having rooms with ceilings, said smoke extraction system comprising:
a multi port manifold for smoke flow disposed in the space above the ceiling; and
said manifold has a multiplicity of dedicated smoke intake ducts attached; and
said intake ducts penetrate said ceiling, forming an intake; and
a back draft damper upon ceiling termination of each of said smoke intake ducts; and
an electric motor with fan blade, integral to said manifold; and
a smoke sensing means; and
a fan actuating relay means associated with said smoke sensor; and
an enlarged exhaust chimney means upon said manifold; and
said exhaust chimney penetrates the building envelope, and
a decorative spark arrestor cap upon said exhaust chimney; and
said smoke extraction system is battery powered; and
said battery is a rechargeable, replaceable battery; and
an electrical recharging means is associated with said battery; and
said smoke sensing means activates said motor with fan blade when a predetermined amount of smoke is detected by said smoke sensing means.

2. A multi port manifold and system for smoke extraction according to claim 1, constructed to be mounted upon the exterior surface of a building.

3. A multi port manifold and system for smoke extraction according to claim 1, constructed to be mounted upon the flat roof surface of a building.

4. A multi port manifold and system for smoke extraction according to claim 1, constructed to be mounted inside a closet area of a building.

5. A multi port manifold and system for smoke extraction according to claim 1, constructed to be mounted within an attic space of a building.

6. A multi port manifold and system for smoke extraction according to claim 1, constructed to be paired together with a twin or several multi port manifolds, for service to larger building interiors.

7. A multi port manifold and system for smoke extraction according to claim 1, constructed with a multi speed fan mechanism.

8. A multi port manifold and system for smoke extraction according to claim 1, constructed with said smoke sensor means integral to said back draft damper means.

9. A multi port manifold and system for smoke extraction according to claim 1, constructed with a back draft damper within said exhaust chimney.

10. A multi port manifold and system for smoke extraction according to claim 1, constructed to be hardwired to a building electrical supply service.

11. The fire containment and smoke extraction system and method of claim 1, including an outdoors audio alarm in association with said system and activating said outdoor alarm when said smoke extraction system is activated by said smoke sensing means.

12. The fire containment and smoke extraction system and method of claim 1, wherein said smoke detection means has ability to telephonically alert local 911 or fire station to occurrence of a fire event at the building, with address identifier message within alert.

13. The fire containment and smoke extraction system of claim 1, with identifying labels, emblem or markings upon exterior of said chimney termination, for visual recognition by fire control personnel when present upon building rooftop.

14. The fire containment and smoke extraction method of claim 1 for containing a building fire within the area of origination by feeding positive airflow to the fire by means of drawing heated air and smoke into said extraction system.
